(19) United States
(12) Patent Application Publication
(10) Pub. No.: US 2021/0222740 A1
(43) Pub. Date: Jul. 22, 2021

(54) ENHANCED CLUTCH PACK ARRANGEMENT WITH SINGLE-SIDED FRICTION DISCS

(71) Applicant: Raybestos Powertrain, LLC, Crawfordsville, IN (US)

(72) Inventors: Przemyslaw A. Zagrodzki, West Lafayette, IN (US); Angela L. Petroski, Waveland, IN (US)

(21) Appl. No.: 17/154,598

(22) Filed: Jan. 21, 2021

Related U.S. Application Data
(60) Provisional application No. 62/963,604, filed on Jan. 21, 2020.

(51) Int. Cl. F16D 13/52; F16D 13/64

(52) U.S. Cl. CPC F16D 13/52; F16D 2200/0021; F16D 2013/642; F16D 13/648

(57) ABSTRACT

A clutch pack arrangement including a plurality of discs having inner splines with each disc having a friction lining attached to a single side of the discs having inner splines; a plurality of discs having outer splines with each disc having a friction lining attached to a single side of the discs having outer splines, said discs having outer splines being space intermittent to said discs having inner splines, and all friction lings are located on the same relative side of the discs having inner and outer splines; and; a plurality of bare steel discs including at least one bare steel disc having an inner spline and at least one bare steel disc having an outer spline, said bare steel discs being located intermittently between said, disc have friction linings attached to one side thereof.

### CROSS-REFERENCE TO RELATED APPLICATION

The present application is a non-provisional utility patent application and claims priority to U.S. provisional patent application Ser. No. 62/963,604, filed on Jan. 21, 2020, the entirety of which is incorporated by reference herein.

### BACKGROUND OF THE INVENTION

### Field of the Invention

The technical field relates generally to torque transfer apparatus such as friction clutches or brakes, and in particular, relates more specifically to multidisc clutches and brakes.

### Description of the Related Art

Torque transfer apparatuses are used in wide variety of application including, for example, clutches and friction brakes for passenger vehicles, commercial vehicles and equipment, industrial vehicles and equipment, agricultural vehicles and equipment, mining vehicles and equipment, marine vessels, and others. These torque transfer apparatuses include at least one or more pairs of surfaces which interact to transfer torque. Typically, such apparatuses include plates or discs which may be arranged, for example, in a friction pack. Applying force to the plate(s) or disc(s) can generate frictional torque resulting in torque transfer. The force which acts in direction normal to friction interfaces can be applied by one or more of a variety of known devices such as a hydraulic piston, electro-hydraulic actuator, electro-mechanical actuator, e.g. electrically driven ball-ramp mechanism, or others.

### SUMMARY OF THE INVENTION

In accordance with one embodiment of the subject invention, a clutch pack arrangement is provided that includes a plurality of discs having inner splines with each disc having a friction lining attached to a single side of the discs; a plurality of discs having outer splines with each disc having a friction lining attached to a single side of the discs, wherein the discs having outer splines are spaces intermittently with the discs having inner splines, and all of the friction linings are located on the same relative side of the discs having inner and outer splines. The clutch pack arrangement also includes a plurality of bare steel discs including at least one bare steel disc having an inner spline and at least one bare steel disc having an outer spline, wherein the bare steel discs are located intermittently between the, discs have friction linings attached to one side thereof.

In one embodiment of the clutch pack arrangement, the discs having friction linings attached to one side thereof are thinner than the bare steel discs.

In another embodiment of the invention of the clutch pack arrangement, the discs having friction linings attached to one side thereof are thicker than the bare steel discs.

The discs having a friction lining attached to one side thereof can be manufactured from a steel material. Also, the discs having a friction lining attached to one side thereof, have an exposed steel surface a side of the disc opposite the side having the friction lining attached thereto.

The clutch pack arrangement can further include active interfaces between a friction lining an and opposing exposed steel surface on one either the discs having a friction lining attached to one side thereof or one of the bare steel discs.

The clutch pack arrangement can also further include at least one passive interface between a bare steel disc and an exposed steel surface of one of the discs having a friction lining attached to one side thereof.

In one embodiment, the passive interface occurs between discs having a friction liner attached to one side and a bare steel disc, wherein both discs have either outer spines or inner spines.

### BRIEF DESCRIPTION OF THE DRAWINGS

The above-mentioned and other features and objects of this invention and the manner of obtaining them will become more apparent, and the invention itself will be better understood by reference to the following description of embodiments of the present invention taken in conjunction with the accompanying figures, wherein:

FIG. 1 is a cross-sectional view of a portion of a prior art torque transfer apparatus such as a friction clutch including a set of friction;

FIG. 2 is an enlarged cross-sectional view of a prior art single sided clutch pack including a bare metal plate on one end thereof;

FIG. 3 is an enlarged cross-sectional view of an embodiment of a clutch pack having single-sided friction discs with relatively thin steel cores and additional bare steel discs in accordance with the invention;

FIG. 4 shows an alternate embodiment of the subject invention of a clutch pack having discs including components analogous to those in FIG. 3 but the relative thicknesses of the discs are different; and.

FIG. 5 shows yet another embodiment of a clutch pack wherein the relation of thicknesses is reversed compared to that in FIG. 4.

Corresponding reference characters indicate corresponding parts throughout the several views. Although the figures represent embodiments of the present invention, the figures are not necessarily to scale and certain features may be exaggerated in order to better illustrate and explain the present invention. The exemplification set out herein illustrates embodiments of the invention, and such exemplifications are not to be construed as limiting the scope of the invention in any manner.

### DETAILED DESCRIPTION OF EMBODIMENTS OF THE INVENTION

For the purpose of promoting an understanding of the principles of the invention, reference will now be made to the embodiments illustrated in the figures, which are described below. It will nevertheless be understood that no limitation of the scope of the invention is thereby intended. The invention includes any alterations and further modifications in the illustrated devices and described methods and further applications of the principles of the invention, which would normally occur to one skilled in the art to which the invention relates.

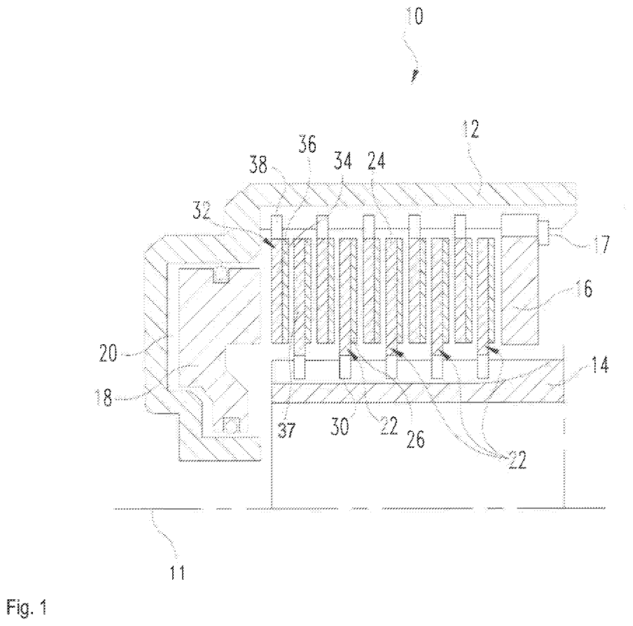

Now referring to FIG. 1, a. friction clutch 10, generally indicted as 10 has components positioned along a center axis 11 around which the friction clutch 10 is symmetrical.

The wet multidisc friction clutch 10 comprises ring-shaped discs of two types: discs 22 with an inner spline 30 and that connect to an inner shaft or hub 14 and discs 32 with an outer spline 38 and connected to an outer basket 12. Discs 22 include one-sided linings 26, and discs 32 include one-sided linings 36. These two types of discs are alternately arranged. The shaft 14 and basket 12 can rotate independently when the discs are separated by small axial clearances. When a clutch apply member 18, which is separated from basket 12 by a space 20 exerts an axial force on the pack of discs 22 and 32, ring-shaped surfaces of every disc come into intimate contact with adjacent discs. In this way, a surface of a disc 22 with inner spline 30 engages a surface of a disc 32 with an outer spline 38. Friction forces at interfaces transfer torque between the hub 14 and the basket 12. On the end of the pack opposite to apply member 18, the pack is supported by a plate 16, often referred to as the backing plate or the end plate.

In order to obtain favorable contact interaction between ring-shaped surfaces in the clutch 10, a pair of mating surfaces is created by two dissimilar materials. Most typically one of the materials, shown at 26 and 36, is a friction composite lining while the other, 24/34 and 37, respectively, is a carbon steel. There are two types of clutch pack arrangements in use. One uses double-sided friction discs where the friction lining is attached to two sides of an inner or outer splined steel core and these friction discs are interleaved with bare steel discs of opposite spline orientation. The other known arrangement, shown in FIG. 1, comprises single-sided friction discs where the friction linings 26 and 36 are attached to only one side of both the outer splined and inner splined steel cores, respectively 22 and 32, and the friction lining faces the steel surface of the adjacent single-sided friction disc, alternating this configuration between inner and outer spline geometries. Each of these pack arrangements has distinct features and one or the other might be preferred depending on duty cycles and clutch design features.

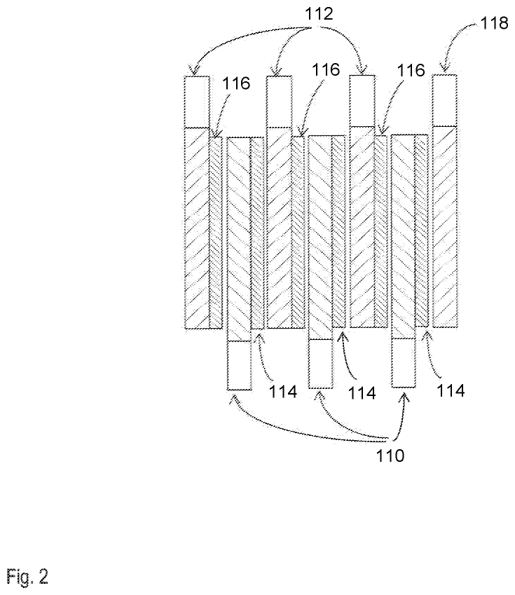

The current invention relates to the single-sided clutch pack configuration shown in FIG. 1. Now referring to FIG. 2, a schematic of a common arrangement of prior art of a single-sided pack is shown. Friction discs with steel cores and inner splines are generally indicted as 110 and Friction discs with steel cores and outer splines are generally indicated as 112. Single-sided friction linings 114 and 116 are attached to friction discs 110, 112, respectively. The thickness of the steel cores of discs 110 and 112 is an important design parameter as it defines the strength of the disc, the thermal capacity of the disc, and the contact pressure in spline connections, to name the most important factors. Therefore, the thickness of the steel cores is one of the carefully considered design parameters of the clutch. While in general cores with inner spline may have a thickness different from that of cores with an outer spline, in most cases they are identical.

In the embodiment shown, the single-sided pack in FIG. 2 includes a bare metal plate, generally indicated as 118. This plate 118 is typically included in a single-sided clutch pack. But there is an alternative arrangement possible, without plate 118. Example of such arrangement is shown in FIG. 1 where single-sided disc 22 at the end of the pack, directly faces backing plate 16. With this arrangement backing plate 16 creates a sliding interface with a single-sided friction disc 22 having a lining 26.

The friction discs with steel cores 110 and 112 in FIG. 2 must be sufficiently thick in order to limit the contact load in the spline connection where the contact pressure is inversely proportional to the thickness. Another important consideration is the thermal capacity (or heat sink) provided by the core. In many clutch applications a large amount of frictional heat is dissipated during the clutch slip. In order to limit the temperature rise in the clutch pack, steel cores are required to provide sufficient thermal capacity, which is proportional to the thickness.

Steel core dimensions established based upon those thermal requirements may be relatively thick. Although they provide sufficient thermal capacity and spline load distribution, relatively thick cores, however, disadvantageously affect other properties or features of the clutch pack. One of such features is thermal deformation under frictional heat when high temperature gradients across the core thickness are produced. This is a common situation where the cores tend to deform and, therefore, the working surface becomes curvilinear. This deformation unfavorably modifies the distribution of the contact pressure at the working interfaces which, in turn, contributes to even worse temperature gradients and can become detrimental to the functionality and performance of the clutch or brake.

The other disadvantageous effect of the relatively thick cores is a high flexural stiffness of the discs. Generally, flexural compliance, or low flexural stiffness, of the clutch discs is a desired feature for at least two known reasons. One is compliant discs better conform to one another producing more uniform distributions of contact pressure; compliant discs better compensate for any geometry imperfections as well as for deformations caused by non-uniform thermal expansion. The other benefit of compliant discs is the reduction of natural frequencies of the clutch pack corresponding to flexural modes. These modes are believed to be related to acoustic noise (NVH) that might be produced by a clutch during clutch slip. Shifting the natural frequencies towards a lower spectrum by reducing flexural stiffness alleviates the problem.

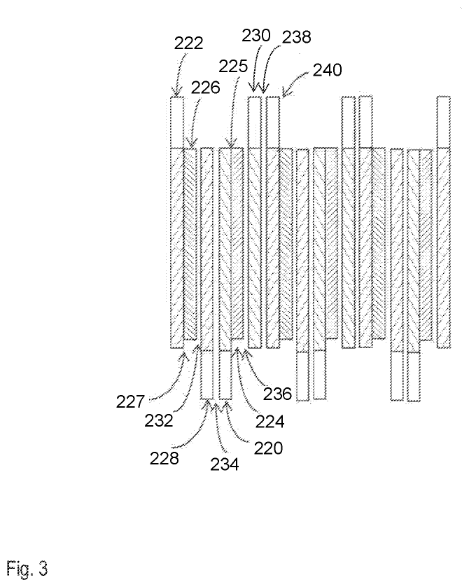

The current invention comprises a clutch pack with single-sided friction discs with relatively thin steel cores and additional bare steel discs arranged as shown in FIG. 3. In FIG. 3, outer spline friction discs, generally indicated as 227, each include a friction lining, generally indicated as 226, adhered to one side of a thinner outer splined steel core 222. Inner splined friction discs, generally indicated as 225, each include a friction lining 224 adhered to a thinner inner splined steel core 220. There are two types of additional bare steel discs: those with an inner spline are generally indicated as 228 and those with an outer spline are generally indicated as 230. A steel disc with an inner spline 228 is placed between each single-sided friction disc with an outer spline 227 on the side of the friction lining 226 and the adjacent single-sided friction disc with an inner spline 225 so that it faces the bare steel core surface of that disc. In this way the working (active) interface 232 is constituted by the surface of the friction lining of single-sided disc with an outer spline 227 and an additional bare steel disc with an inner spline 228. Adding a steel disc to the pack creates an additional interface. This additional interface is constituted by a surface of an additional bare steel disc with an inner spline 228 and a steel core surface of single-sided disc with an inner spline, generally indicated as 225. Since both of these discs are splined to the same, inner spline in this case, the additional interface 234 is a non-working (passive) steel-on-steel surface. Similarly, the additional bare steel disc with an outer spline 230 is placed between each single-sided friction disc with an inner spline 225 on the side of the friction lining, which is generally indicated as 224, and the adjacent single-sided friction disc with an outer spline 240 so that it faces the bare steel core surface of that friction disc 240. The working (active) interface, generally indicated as 236, is constituted by the surface of the friction material of a single-sided disc with an inner spline 225 and the additional bare steel disc with an outer spline 230. An additional interface, generally indicated as 238, is constituted by a surface of an additional bare steel disc 230 with an outer spline and a steel core surface of single-sided disc with an outer spline 240. The additional interface 238 that is between same splined parts, outer spline in this case, is a non-working (passive) steel-on-steel surface.

One embodiment of current invention includes a clutch pack with additional bare steel discs with an inner spline 228 and additional bare steel discs with an outer spline 230 arranged as shown in FIG. 3. The number of additional bare steel discs with an inner spline 228 is equal to the number of friction discs with an inner spline 225. Similarly, the number of additional bare steel discs with an outer spline 230 is equal to the number of friction discs with an outer spline 27. The thicknesses of steel cores of the friction discs and the thicknesses of additional steel discs are selected based on required thermal capacity of the pack and spline contact load. This implies that a sum of the thicknesses of a core of a single-sided friction disc and the additional steel disc according to current invention is approximately equal to the thickness of a core in prior art single-sided clutch pack design. In FIG. 3, the effective steel thickness that provides sufficient thermal capacity for the working interface 232 is the sum of the thicknesses of additional steel disc 228 plus friction disc core 220; which is approximately the same thickness as the single steel core of friction disc in clutch 10 in FIG. 1 of prior art. The total thickness of the whole clutch pack according to current invention is approximately the same as in prior art clutch pack design of the same torque and thermal capacity.

In one embodiment of current invention, cores and additional steel discs have identical thicknesses. In this case, the thickness of each of them is approximately equal to half of the thickness of a steel core in single-sided clutch pack according to prior art. Since flexural stiffness of a disc is proportional to the third power of the thickness, each steel core and additional steel disc in a clutch pack, according to current invention, have flexural stiffness of about 8 times less than that in prior art single-sided clutch pack design. At the same time, thermal capacity and nominal spline contact load in the clutch pack according to current invention remains similar to that according to prior art.

In one embodiment of current invention with cores and additional steel discs of identical thickness, the stamped or machined steel cores used to make single-sided friction discs can also serve as the additional steel discs, which is beneficial for optimizing common parts and tooling for manufacturing.

Other believed benefits of current invention include that thin cores and steel discs can be manufactured using conventional blanking process, while thicker cores and steel discs oftentimes require a fine blanking process, which is generally more expensive. Furthermore, contact load carried by the spline teeth will be distributed between twice as many teeth than in the case of prior art thick cores. Although nominal spline contact area remains the same as in prior art clutch pack design, the contact load tends to be more uniformly distributed among the teeth.

Another potential benefit of the current invention is the possibility of utilizing the same friction discs in various applications: if thin cores satisfy the thermal and mechanical load requirements, a prior art clutch pack can be assembled from those discs (without additional steel discs); if thermal loads are too high, the thermal capacity of the clutch pack can be increased by implementing the additional steel discs as described in this invention.

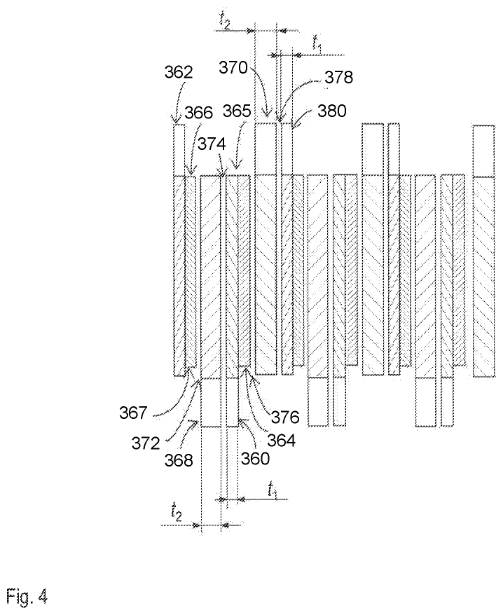

Now referring to FIG. 4, another embodiment of the current invention is shown with discs and components analogous to those in FIG. 3 but relative thicknesses are different. Specifically, the thickness of additional inner and outer splined bare steel discs 368 and 370 is t₂ and is greater than the thickness t₁ of inner and outer splined steel cored discs 360/365 and 362/367/380, respectively, having single-sided friction discs linings 364 and 366, respectively, such that t₂>t₁. A working active interface 372 is shown between friction discs lining 366 and bare steel inner splined disc 368, and a working active interface 376 is shown between friction discs lining 364 and bare steel outer splined disc 370. A passive non-working interface 374 is shown between inner splined steel bare steel disc 368 and the steel side of inner splined steel core 360/365, and a passive non-working interface 378 is shown between outer splined steel bare steel disc 370 and the steel side of outer splined steel core 380.

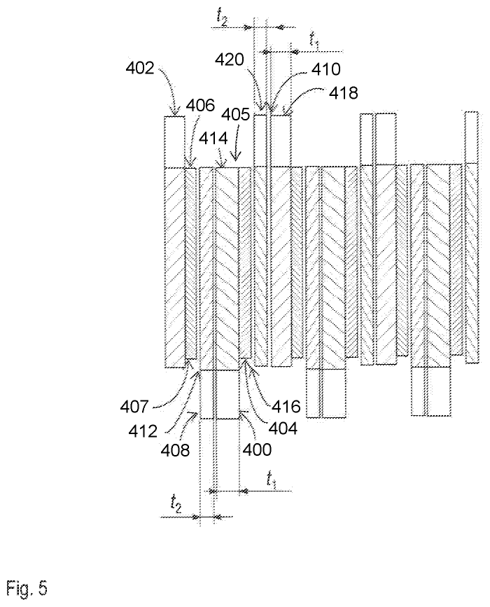

Yet another embodiment is show in FIG. 5, where relation of thicknesses is reversed compared to that in FIG. 4, namely t₂<t₁. Specifically, thickness of additional inner and outer splined bare steel discs 408 and 420 is t₁ and is greater than the thickness t₂ of inner and outer splined steel cored discs 400/405/414 and 402/418, respectively, having single-sided friction discs linings 404 and 406/407, respectively, such that t₂<t₁. A working active interface 412 is shown between friction discs lining 406/407 and bare steel inner splined disc 408, and a working active interface 416 is shown between friction discs lining 404 and bare steel outer splined disc 420. A passive non-working interface 410 is shown between outer splined steel bare steel disc 420 and the steel side of outer splined steel core 418.

In most general case, thickness of friction discs with outer spline can be different from the thickness of friction discs with inner spline. And also thickness of additional steel discs with outer spline can be different from the thickness of additional steel discs with inner spline.

It can be seen from FIGS. 1 and 2 (prior art) as well as from FIGS. 3 to 5 showing embodiments of the present invention that all surfaces of the friction lining in a single-sided clutch pack face in the same direction. For example, rings of friction material lining shown at 114 and 116 in FIG. 2 face to the right. This means that a single-sided pack has an axial orientation. Orientation is important when the pack is placed inside the clutch. Generally, it can face either backing plate, as shown in FIG. 1, or, alternatively, face the piston or apply member 18. In the latter case, an additional steel disc with outer spline is generally added between the apply member and the pack to create an acceptable working interface with the first friction disc in the pack. There are a number of factors, mostly driven by consideration of the mode of mechanical and thermal deformation of clutch components, that may dictate one or another orientation of a single-sided clutch pack relative to the piston and the backing plate. The current invention is not limited to any pack orientation. That means that clutch pack per current invention can either face the backing plate or the piston/apply member depending on those additional considerations.

While the invention has been taught with specific reference to these embodiments, one skilled in the art will recognize that changes can be made in form and detail without departing from the spirit and scope of the invention. For instance, although steel is called out for the discs in the described embodiments, other suitable materials may be used or substituted, including composite materials, and the friction discs may be a composite material or of a single material. This application is intended to cover any variations, uses, or adaptations of the invention using its general principles. Further, this application is intended to cover such departures from the present disclosure as has come within the known or customary practice in the art to which the invention pertains and which fall within the limits of the appended claims or equivalents thereof.

1. A clutch pack arrangement comprising:
a plurality of discs having inner splines with each disc having a friction lining attached to a single side of the discs having inner splines;
a plurality of discs having outer splines with each disc having a friction lining attached to a single side of the discs having outer splines, said discs having outer splines being space intermittent to said discs having inner splines, and all friction lings are located on the same relative side of the discs having inner and outer splines; and;
a plurality of bare steel discs including at least one bare steel disc having an inner spline and at least one bare steel disc having an outer spline, said bare steel discs being located intermittently between said, disc have friction linings attached to one side thereof.

2. The clutch pack arrangement as set forth in claim 1, wherein said discs having friction linings attached to one side thereof are thinner than said bare steel discs.

3. The clutch pack arrangement as set forth in claim 1, wherein said discs having friction linings attached to one side thereof are thicker than said bare steel discs.

4. The clutch pack arrangement as set forth in claim 1, wherein said discs having a friction lining attached to one side are manufactured from a steel material.

5. The clutch pack arrangement as set forth in claim 4, wherein said discs having a friction lining attached to one side thereof, have an exposed steel surface a side of said disc opposite said side having the friction lining attached thereto.

6. The clutch pack arrangement as set forth in claim 5, further including active interfaces between a friction lining an and opposing exposed steel surface on one either said discs having a friction lining attached to one side thereof or one of said bare steel discs.

7. The clutch pack arrangement as set forth in claim 6, further including at least one passive interface between a bare steel disc and an exposed steel surface of one of said discs having a friction lining attached to one side thereof.

8. The clutch pack arrangement as set forth in claim 7, wherein said passive interface occurs between discs having a friction liner attached to one side and a bare steel disc, wherein both discs have either outer spines or inner spines.
